(19) United States
(12) Patent Application Publication
(10) Pub. No.: US 2026/0102749 A1
(43) Pub. Date: Apr. 16, 2026

(54) DISPERSION COMPOSITION PRODUCTION METHOD

(71) Applicants: artience Co., Ltd., Tokyo (JP); TOYOCOLOR CO., LTD., Tokyo (JP)

(72) Inventors: Tomoaki MASUOKA, Tokyo (JP); Yu AOTANI, Tokyo (JP)

(73) Assignees: artience Co., Ltd., Tokyo (JP); TOYOCOLOR CO., LTD., Tokyo (JP)

(21) Appl. No.: 18/728,078

(22) PCT Filed: Feb. 1, 2023
(86) PCT No.: PCT/JP2023/003286

§ 371 Date: Jul. 10, 2024

(30) Foreign Application Priority Data
Feb. 2, 2022 (JP) 2022-014907

(51) Int. Cl. B01F 35/71; B01F 23/50; B01F 35/90

(52) U.S. Cl. CPC B01F 35/7174; B01F 23/51; B01F 23/56; B01F 35/90; B01F 2035/98

(57) ABSTRACT

A dispersion composition production method uses a dispersion device including: a dispersion mechanism dispersing a raw material composition; a supply mechanism equipped with a plunger part and supplying the raw material composition to the dispersion mechanism; and a cooling mechanism cooling the plunger part using a cooling liquid medium. The raw material composition contains a non-aqueous dispersion medium and a dispersoid. The cooling liquid medium is a liquid medium that results in 0-50 particles 10 μm or more in the flocculation test below: dispersing a composition identical to the raw material composition; preparing a test dispersion liquid having a particle size of less than 10 μm; preparing a test sample by mixing the test dispersion liquid and the cooling liquid medium at a mass ratio of 1:1; and identifying the number of particles of 10 μm or more in the test sample.

### TECHNICAL FIELD

The present invention relates to a dispersion composition production method.

### RELATED ART

Examples of a method for dispersing a dispersoid in a non-aqueous dispersed medium include a stirrer, a ball mill disperser, a bead mill disperser, an ultrasonic disperser, a single-screw kneader, a multi-screw kneader, a roll mill disperser, and a high-pressure homogenizer. From the viewpoint of dispersion efficiency, a bead mill disperser is widely used. While the bead mill disperser has an advantage that it applies an impact to a dispersoid and finely disperses the dispersoid, the dispersoid may be damaged by the impact and the intrinsic properties of the dispersoid may therefore deteriorate. In the high-pressure homogenizer, by a method for discharging a treatment liquid from a nozzle, or a method for passing the treatment liquid through a homogenization valve, or the like, the treatment liquid can be homogenously dispersed. Since the treatment liquid is supplied at high pressure in order to improve dispersion efficiency, the dispersoid can be finely dispersed by shearing force and collision between the treatment liquids, collision with a wall surface of the homogenization valve, or the like.

For the reasons that a flow rate of a treatment liquid can be increased and a nozzle that may cause clogging is unnecessary, a valve-type high-pressure homogenizer is suitable for mass production, and may be used as a homogenization device for a water system such as a dairy product or a beverage. Since the dairy product and the like have a low solid content and are water-based, they have a small effect on a member of a dispersion device. For example, there is an advantage that deterioration of a packing or the like of a high-pressure pump is slow and a replacement interval is long. Even if the packing or the like of the high-pressure pump deteriorates and the treatment liquid leaks out, the treatment liquid can be collected and easily treated since it is water-based. In the high-pressure pump, since a high pressure is loaded and heat is generated, there may be provided a cooling mechanism using cooling water. Even if a water-based treatment liquid leaks from the high-pressure pump, since the water-based treatment liquid is collected together with the cooling water, few problems occur.

In recent years, the high-pressure homogenizer has also been used as a dispersion device for a solvent system such as ink, and has been used as a dispersion device particularly for a solvent system of a carbon material containing a carbon nanotube. A solvent-based treatment liquid is likely to act on the packing or the like of the high-pressure pump. Deterioration of the packing may shorten the replacement interval of the packing, thus reducing work efficiency. Furthermore, there is also a problem that leakage of the solvent from the high-pressure pump is increased due to deterioration of the packing.

Patent Document 1 has proposed the following. By removing an organic solvent from a mixture containing water and an organic solvent solution of a polymer, subjecting the desolventized mixture to a dispersion treatment and producing a water dispersion of pigment-containing polymer particles, evaporation of the organic solvent in the dispersion treatment as well as disassembly and cleaning of a dispersion device is prevented, workability is improved, and deterioration of the packing of the dispersion device is prevented.

Patent Document 2 has proposed the following. In a method in which a coarse dispersion liquid containing a carbon nanotube and a solvent is stored in a tank and the coarse dispersion liquid is sent to a disperser by a high-pressure pump for dispersion treatment, by cooling a high-temperature carbon nanotube dispersion liquid discharged from the disperser, formation of bubbles in the dispersion liquid is prevented, and by reducing back pressure of the dispersion liquid in multiple stages, formation of bubbles in the dispersion liquid at the time of release of atmospheric pressure is prevented, and dispersibility of the carbon nanotube is improved.

### PRIOR-ART DOCUMENTS

### Patent Documents

Patent Document 1: Japanese Patent Laid-open No. 2001-247810
Patent Document 2: WO 2015/015758

### SUMMARY OF THE INVENTION

### Problems to be Solved by the Invention

In the case of producing a non-aqueous dispersion composition, when the cooling water that cools the high-pressure pump mixes with a raw material composition leaking from the high-pressure pump, a non-aqueous dispersed medium is mixed into waste cooling water together with the dispersoid, making it difficult to reuse the cooling water as water or to dispose of the cooling water. When water is mixed into a system in which dispersion stability of the dispersoid in the non-aqueous dispersed medium is maintained, stability of the system may be disrupted, and the dispersoid may aggregate to form aggregates. Since the liquid leakage includes the dispersoid as well as the non-aqueous dispersed medium, a process for removing solid content by filtration or the like is additionally provided in order to reuse the cooling water. However, when aggregates are formed, there is a problem that it is difficult to remove the solid content.

If circulation efficiency for reusing cooling water is reduced due to such a defect, cooling efficiency of the high-pressure pump may be reduced, and a member of the high-pressure pump may be exposed to high temperatures and may deteriorate. For example, a seal member such as a packing of the high-pressure pump may deteriorate due to high temperatures, causing pressure loss in the high-pressure pump. Deterioration of the packing reduces operating efficiency and shortens a replacement interval or the like, thus becoming a main cause of reduced productivity.

In Patent Document 1, deterioration of a packing of a high-pressure homogenizer is prevented by pre-removal of the organic solvent contained in the water dispersion of pigment-containing polymer particles. However, the problem that causes the deterioration of the packing in the case where the dispersion composition is a non-aqueous dispersed medium cannot be solved. In Patent Document 2, the coarse dispersion liquid is supplied to the high-pressure homogenizer by the high-pressure pump, and attention is only paid to cooling the dispersion liquid after the dispersion treatment by the high-pressure homogenizer, preventing the formation of bubbles and improving dispersibility. However, reduction of productivity due to the high temperature of the high-pressure pump has not been discussed.

A pressurization mechanism of the high-pressure homogenizer loads pressure on the treatment liquid inside a cylinder by a plunger, and supplies the high-pressure treatment liquid to a dispersion section composed of a nozzle or a homogenization valve or the like. Since frictional heat is generated on a sliding surface between a seal within the cylinder and the plunger, there is a method for cooling the plunger and preventing deterioration of the seal member. Furthermore, since the plunger reciprocates within the cylinder, the treatment liquid is likely to leak as the plunger reciprocates. In the case where the treatment liquid is a non-aqueous dispersed medium, the above-mentioned problem may occur.

One object of the present invention is to prevent reduction of cooling efficiency of a plunger part, improve dispersibility of a dispersion composition, and improve productivity.

### Means for Solving the Problems

According to the intensive studies conducted by the present inventors in order to solve the above problems, in a process for applying a cooling liquid medium to a plunger part, the cooling liquid medium is a liquid medium that results in the number of particles of 10 μm or more in a predetermined flocculation test being 0 to 50. Thereby, in a method for producing a dispersion composition containing a non-aqueous dispersed medium, by selecting a liquid medium having high affinity with a raw material composition as the cooling liquid medium that cools the plunger part, even if the raw material composition leaks from a cylinder part and contacts the cooling liquid medium, generation of aggregates due to a dispersoid or dispersant or the like can be suppressed. Accordingly, in the case of reusing and circulating the cooling liquid medium, reduction of cooling efficiency can be prevented. For example, deterioration of a seal member such as a packing can be prevented, the life of the seal member can be extended, and long-term operation is made possible. The replacement interval of the seal member can be increased, and workability can be improved. Pressure loss due to deterioration of the seal member can be suppressed, the treatment liquid can be supplied from a high-pressure pump to a dispersion mechanism at high pressure, and dispersibility of the dispersion composition can be improved.

That is, the present invention includes the following embodiments. Embodiments of the present invention are not limited to the following.

<1> Provided is a dispersion composition production method using a dispersion device. The dispersion device is equipped with a dispersion mechanism that disperses a raw material composition, a supply mechanism that includes a plunger part and supplies the raw material composition to the dispersion mechanism, and a cooling mechanism that cools the plunger part using a cooling liquid medium. The raw material composition contains a non-aqueous dispersed medium and a dispersoid. The cooling liquid medium is a liquid medium that results in the number of particles of 10 μm or more in a flocculation test mentioned below being 0 to 50.

### (Flocculation Test)

A composition identical to the raw material composition is subjected to a dispersion treatment using a bead mill or a high-pressure homogenizer. A test dispersion liquid is prepared having a particle size of less than 10 μm as measured with a grindometer (0 to 100 μm). The test dispersion liquid and the cooling liquid medium are mixed at a mass ratio of 1:1 at 25° C. to prepare a test sample, and the number of particles of 10 μm or more in the test sample is identified using a grindometer (0 to 100 μm).

<2> In the dispersion composition production method as described in <1>, the non-aqueous dispersed medium of the raw material composition and the cooling liquid medium contain the same liquid medium.

<3> In the dispersion composition production method as described in <1> or <2>, a leakage rate of the raw material composition from a supply mechanism per 100 hours of operation, which is expressed by the following expression (1), is 0.2% or less:

$$leakage rate ( \% ) = ( leakage amount ( L ) of raw material composition from supply mechanism / supply amount ( L ) of raw material composition ) \times 100 \qquad ( 1 )$$

<4> Provided is a dispersion composition production method using a dispersion device. The dispersion device is equipped with a dispersion mechanism that disperses a raw material composition, a supply mechanism that includes a plunger part and supplies the raw material composition to the dispersion mechanism, and a cooling mechanism that cools the plunger part using a cooling liquid medium. The raw material composition contains a dispersoid, a non-aqueous dispersed medium, and a dispersant. The cooling liquid medium is a liquid medium in which no solid precipitates are formed at 25° C. in a state in which a solution of the non-aqueous dispersed medium containing 5% by mass of the dispersant and the cooling liquid medium are mixed at a mass ratio of 1:1.

<5> Provided is a dispersion composition production method using a dispersion device. The dispersion device is equipped with a dispersion mechanism that disperses a raw material composition, a supply mechanism that includes a plunger part and supplies the raw material composition to the dispersion mechanism, and a cooling mechanism that cools the plunger part using a cooling liquid medium. The raw material composition contains a dispersoid, a non-aqueous dispersed medium, and a dispersant. At 25° C., the cooling liquid medium is a liquid medium in which 0.1% by mass or more of the dispersant contained in the raw material composition is dissolved.

### Effects of the Invention

According to one embodiment of the present invention, reduction of cooling efficiency of the plunger part can be prevented, dispersibility of the dispersion composition can be improved, and productivity can be improved.

### BRIEF DESCRIPTION OF THE DRAWINGS

FIG. 1 is a schematic diagram showing an example of a dispersion device.

FIG. 2 is a cross-sectional view schematically showing a high-pressure pump and a cooling mechanism of an example of a dispersion device.

FIG. 3 is a cross-sectional view schematically showing a homogenization valve of a dispersion section of an example of a dispersion device.

### DESCRIPTION OF THE EMBODIMENTS

A dispersion composition production method being an embodiment of the present invention will be described below in detail. The present invention is not limited to the following embodiments, and the present invention also includes embodiments implemented without changing the gist.

### <Dispersion Device>

Hereinafter, a method for producing a dispersion composition containing a dispersoid and a non-aqueous dispersed medium using a dispersion device will be described. The non-aqueous dispersed medium may further contain a dispersant. The dispersion composition can be produced using a dispersion device equipped with: a dispersion mechanism, dispersing a raw material composition; a supply mechanism, including a plunger part and supplying the raw material composition to the dispersion mechanism; and a cooling mechanism, cooling the plunger part using a cooling liquid medium. The raw material composition is a composition containing mixed raw materials of the dispersion composition. The raw material composition may be a composition in a mixed state, or may be a composition in a coarsely dispersed state after mixing. Examples of such a dispersion device include a high-pressure homogenizer. In the high-pressure homogenizer, by reciprocation of a plunger, the raw material composition can be supplied at high pressure from a high-pressure pump to a dispersion section, and the raw material composition can be subjected to a dispersion treatment in the dispersion section. In one example of the dispersion section, the raw material composition is injected at high pressure from a minute opening at a tip of a nozzle, and the dispersoid can be dispersed in the non-aqueous dispersed medium by collision and shearing force between the raw material compositions. In another example of the dispersion section, by supplying the raw material composition to a homogenization valve at high pressure, and bringing the raw material composition into collision with a wall surface of the homogenization valve to apply an impact, the dispersoid can be dispersed in the non-aqueous dispersed medium. A method for performing a dispersion treatment using a homogenization valve makes it possible to increase a flow rate of the raw material composition and to avoid problems such as nozzle clogging, and is suitable for mass production. The pressure at which the raw material composition is supplied to the dispersion section is preferably 10 to 150 MPa. In the case where the dispersion section is of a nozzle type, the pressure at which the raw material composition is supplied to the dispersion section is preferably within a normal range of 60 to 150 MPa, more preferably 80 to 150 MPa, and even more preferably 100 to 150 MPa. In the case where the dispersion section is of a valve type, the pressure at which the raw material composition is supplied to the dispersion section is preferably within a normal range of 10 to 150 MPa, more preferably 40 to 150 MPa, and even more preferably 80 to 150 MPa. Furthermore, from the viewpoint of dispersion efficiency, a valve-type homogenizer and a nozzle-type homogenizer may be used together for dispersion. Furthermore, from the viewpoint of adjusting a dispersion state, a bead mill or a high-shear mixer other than the high-pressure homogenizer may be used together for dispersion.

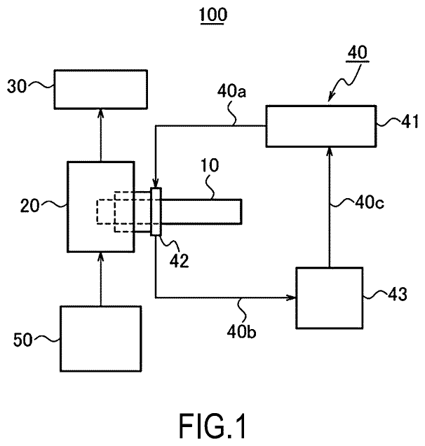

FIG. 1 shows a schematic diagram of an example of a dispersion device. A dispersion device 100 includes a plunger 10, a high-pressure pump 20, a dispersion section 30, and a cooling mechanism 40. A raw material composition tank 50 is a container containing a raw material composition to be supplied to the high-pressure pump 20. The high-pressure pump 20 includes a supply port 22 to which the raw material composition is supplied from the raw material composition tank 50, and a discharge port 23 from which the raw material composition is discharged to the dispersion section 30. The high-pressure pump 20 includes a cylinder part 21 that supports the plunger 10 so that the plunger 10 is reciprocable in an axial direction. The cylinder part 21 may be provided with a sealing mechanism so as to prevent the raw material composition and the pressure from leaking from the high-pressure pump 20 to the outside. Examples of the sealing mechanism include a seal member arranged over the entire circumference in a circumferential direction on an inner periphery of the cylinder part 21. A gland packing being an example of the seal member is composed of one or a combination of: an organic fiber, such as aramid fiber, PTFE fiber, and carbonized fiber; an inorganic fiber, such as carbon fiber and metal fiber; and a natural fiber, such as ramie fiber.

The plunger 10 has one end inserted into the high-pressure pump 20, and has the other end extending outside the high-pressure pump 20 and supported by the cylinder part 21. Preferably, a sliding surface between the plunger 10 and the cylinder part 21 is slidably sealed to thereby prevent liquid leakage of the raw material composition from the high-pressure pump 20. Further preferably, pressure loss due to the outflow of air from the high-pressure pump 20 to the outside is thereby prevented from occurring. By reciprocation of the plunger 10 in the axial direction, the volume of a pressure chamber of the high-pressure pump 20 is changed. When the plunger 10 is pulled out from the high-pressure pump 20 and the volume of the pressure chamber is increased, the raw material composition is suctioned in from the supply port 22 of the high-pressure pump 20. When the plunger 10 is pushed out to the high-pressure pump 20 and the volume of the pressure chamber is decreased, the raw material composition is discharged from the discharge port 23 of the high-pressure pump 20. The supply port 22 and the discharge port 23 of the high-pressure pump 20 may each be provided with a valve to prevent backflow of the raw material composition.

The raw material composition discharged from the high-pressure pump 20 is supplied to the dispersion section 30 at high pressure. The dispersion section 30 may be of a nozzle type or a valve type. Since it is possible to supply a large amount of raw material composition at high pressure to the dispersion section 30 using the plunger 10, the dispersion section 30 is preferably of a valve type, and is specifically preferably a homogenization valve. After the dispersion treatment, the dispersion composition in which the dispersoid is dispersed in the non-aqueous dispersed medium may be obtained. Although not illustrated, the dispersion composition that has undergone the dispersion treatment can be collected into a dispersion composition tank by piping from a discharge port of the dispersion section 30.

The cooling mechanism 40 includes a cooling liquid medium tank 41 and a cooling section 42. The cooling mechanism 40 includes: piping 40a, supplying a liquid medium from the cooling liquid medium tank 41 to the cooling section 42; and piping 40b, discharging the liquid medium from the cooling section 42. The piping 40b is connected to a collection container 43 and is able to collect a used liquid medium into the collection container 43. In another example, the liquid medium collected into the collection container 43 may be filtered, and the liquid medium from which the solid content has been removed may be recirculated through piping 40c into the cooling liquid medium tank 41 for reuse. The cooling section 42 is a member that cools the plunger 10 extending from the high-pressure pump 20 to the outside. The cooling section 42 is, for example, a member that surrounds an outer periphery of the plunger 10 extending to the outside of the high-pressure pump 20 and covers an opening of the cylinder part 21 in a fluid-tight manner. By filling the inside of the cooling section 42 with the cooling liquid medium, the cooling liquid medium directly contacts the openings of the plunger 10 and the cylinder part 21 and cooling is performed. Since an outer peripheral surface of the plunger 10 is cooled and the plunger 10 continues to reciprocate, the cooled outer peripheral surface portion of the plunger 10 enters the inside of the cylinder part 21 of the high-pressure pump 20, and even the inside of the cylinder part 21 can be cooled. Accordingly, the seal member such as a gland packing arranged on an inner peripheral surface of the cylinder part 21 can be cooled. The cooling liquid medium is supplied from the cooling liquid medium tank 41 to the cooling section 42 through the piping 40a. The cooling liquid medium is discharged from the cooling section 42 to the collection container 43 through the piping 40b. Although not illustrated, the piping 40b from the cooling section 42 to the collection container 43 may not be provided, and the cooling liquid medium discharged from the cooling section 42 may be caused to immediately fall into the collection container 43 or a tray or the like for collection. The collection container 43 may not be provided, and the cooling liquid medium discharged from the cooling section 42 may be immediately returned into the cooling liquid medium tank 41.

In another example of the cooling mechanism, although illustrated, a supply port for the cooling liquid medium may be provided in an upper part of a plunger extending from a high-pressure pump, and the cooling liquid medium may be directly dropped to the plunger for cooling. In this case, the cooling liquid medium that falls after dropping to the plunger can be collected by a collection container or a tray or the like.

In still another example of the cooling mechanism, although illustrated, cooling piping for the cooling liquid medium may be arranged inside a cylinder part. By supplying the cooling liquid medium to this cooling piping and cooling the inside of the cylinder part by the cooling piping, the seal member arranged on the inner peripheral surface of the cylinder part and the plunger sliding thereon may be cooled. The cooling liquid medium supplied to the cooling piping inside the cylinder part is discharged from an opening of the cylinder part. For example, the cooling liquid medium discharged from the cooling piping is the mixture may be discharged into the cooling section 42, or may be collected into the collection container 43 by separate piping, or may be caused to immediately fall into the collection container 43 or a tray for collection. In the method of any of the above cooling mechanisms, since the cooling liquid medium directly contacts the plunger, if the raw material composition leaks from the high-pressure pump via the cylinder part, the raw material composition may contact the cooling liquid medium.

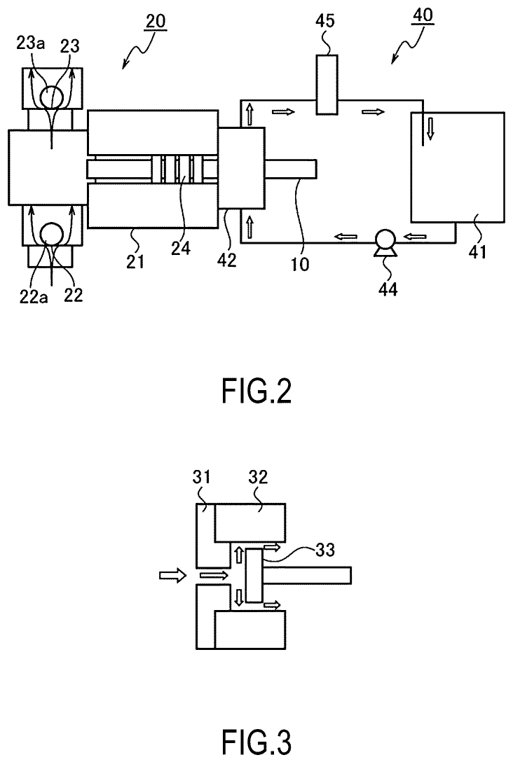

A specific example of the dispersion device will be described with reference to FIG. 2 and FIG. 3. Members common to those in FIG. 1 are assigned with the same reference numerals, and portions that are not particularly described are as described in FIG. 1 above. FIG. 2 is a cross-sectional view schematically showing the high-pressure pump 20 and the cooling mechanism 40 of the dispersion device. In FIG. 2, the high-pressure pump 20 includes: the cylinder part 21; a gland packing 24, arranged on the inner peripheral surface of the cylinder part 21; and a ball valve 22′ and a ball valve 23′, respectively arranged at the supply port 22 and the discharge port 23. The cooling mechanism 40 includes the cooling liquid medium tank 41, the cooling section 42, a pump 44, and a heat exchanger 45. The plunger 10 is reciprocable and is slidably supported in a fluid-tight manner by the gland packing 24 in the cylinder part 21. By reciprocation of the plunger 10, the raw material composition is supplied to and discharged from the high-pressure pump 20 in the directions of arrows in the figure. In the cooling mechanism 40, in the directions of arrows in the figure, the cooling liquid medium is sent from the cooling liquid medium tank 41 by the pump 44 and is filled into the cooling section 42; next, the heated cooling liquid medium after cooling is discharged from an upper part of the cooling section 42 and sent to the cooling liquid medium tank 41 for circulation. The heat exchanger 45 may be provided between piping from the cooling section 42 to the cooling liquid medium tank 41, and the heated cooling liquid medium can be cooled and then circulated.

FIG. 3 is a cross-sectional view schematically showing a homogenization valve of the dispersion section 30. In FIG. 3, the homogenization valve of the dispersion section 30 includes a valve seat 31, an impact ring 32, and a homogeneous valve 33. In the directions of the arrows in the figure, the raw material composition supplied from the high-pressure pump 20 is supplied to the homogenization valve at high pressure, subjected to fine dispersion treatment, and then discharged from a discharge port as shown in the attached figure.

As a valve-type high-pressure homogenizer being an example of the dispersion device, “HC3 Series” manufactured by Sanmaru Machinery, “HV-H Series” manufactured by Izumi Food Machinery, “R-Model” manufactured by SPX Flow, or the like, can be used. As another example of the dispersion device, a nozzle-type high-pressure homogenizer can be used. As the nozzle-type high-pressure homogenizer, “Genas PY” manufactured by Genas, “Starburst” manufactured by Sugino Machine, “Nanomizer” manufactured by Nanomizer, or the like, can be used. However, the present invention is not limited thereto. The nozzle-type high-pressure homogenizer includes a pump and one or more nozzles. The nozzle may be of various shapes for performing the dispersion treatment. For example, there is a type in which raw materials collide with each other at high pressure, a type in which a high-pressure raw material may collide with a ceramic ball, or pass through a slit and be treated by the shearing force thereof, and a type in which cavitation caused by a jet of a high-pressure raw material is utilized. However, the present invention is not limited thereto.

### <Flocculation Test>

In the production of a dispersion composition containing a non-aqueous dispersed medium, in the case where the cooling liquid medium is water, if the raw material composition leaks, the stability of the system of the dispersoid and the non-aqueous dispersed medium of the raw material composition may be disrupted due to mixing with water, and the dispersoid may aggregate to form aggregates. Furthermore, if the raw material composition contains a dispersant together with the dispersoid, the stability of the system is likely to be disrupted by water, and aggregates are relatively likely to be formed. Since these aggregates accumulate and clog piping or a tank for discharging the cooling liquid medium, cooling efficiency of the plunger may be reduced, the plunger and members around may be exposed to high temperatures, and deterioration of the seal member such as the gland packing, in particular, may be caused. Due to deterioration of the seal member, pressure loss may occur, the pressure loaded by the plunger may be reduced, the pressure of the raw material composition supplied to the dispersion section may be reduced, and dispersibility may be reduced. Since replacement work of the seal member is performed after operation of the dispersion device is stopped and the raw material composition is discharged, work time is increased, thus becoming a main cause of reduced productivity. In particular, since the gland packing is costly, frequent replacement thereof leads to reduction of production efficiency.

Accordingly, the cooling liquid medium is preferably a liquid medium that results in the number of particles of 10 μm or more in a flocculation test mentioned below being 0 to 50.

### (Flocculation Test)

A composition identical to the raw material composition is subjected to a dispersion treatment using a bead mill or a high-pressure homogenizer. A test dispersion liquid is prepared having a particle size of less than 10 μm as measured with a grindometer (0 to 100 μm). The test dispersion liquid and the cooling liquid medium are mixed at a mass ratio of 1:1 at 25° C. to prepare a test sample, and the number of particles of 10 μm or more in the test sample is identified using a grindometer (0 to 100 μm).

In the flocculation test, the number of particles of 10 μm or more in the cooling liquid medium is preferably 50 or fewer, more preferably 30 or fewer, even more preferably 10 or fewer, and yet even more preferably 3 or fewer. More preferably, in the flocculation test, the number of particles of 10 μm or more in the cooling liquid medium is zero, that is, no particles of 10 μm or more are observed. By satisfying this condition, even if the raw material composition leaks from the supply mechanism and contacts the cooling liquid medium during operation of the dispersion device, aggregates can be prevented from being formed in the piping or the collection container or the like for discharging the cooling liquid medium.

The test dispersion liquid is prepared by subjecting a composition identical to the raw material composition to a dispersion treatment and performing the dispersion treatment until a particle size of less than 10 μm as measured with a grindometer (0 to 100 μm) is achieved. The conditions of the dispersion treatment vary depending on the type of the raw material composition. It is sufficient if the raw material composition is subjected to the dispersion treatment and the dispersion treatment is performed until achieving a degree of dispersion that a particle diameter is less than 10 μm as measured with a grindometer (0 to 100 μm) as a result. For example, a raw material composition having low aggregability may be produced by coarse dispersion using a bead mill; a raw material composition having high aggregability may be finely dispersed using a high-pressure homogenizer. The particle size of the test dispersion liquid is measured using a grindometer having a groove depth of 0 μm to 100 μm and a scale interval of 10 μm.

The test sample is prepared by mixing the test sample and the cooling liquid medium at a mass ratio of 1:1 at 25° C. A mixing method may be any method for thoroughly mixing the test sample and the cooling liquid medium, and the mixing may be performed using a stirring device. As the stirring device, it is preferable to use a rotation-revolution stirring device since bubbles generated during mixing can be removed. For example, stirring may be performed at 2,000 rpm for 30 seconds using the rotation-revolution stirring device. The number of particles of 10 μm or more in the obtained test sample is identified using a grindometer (0 to 100 μm) at 25° C. For identifying the number of particles of 10 μm or more in the test sample, a grindometer having a groove depth of 0 μm to 100 μm and a scale interval of 10 μm is used. After production of the test sample, the number of particles of 10 μm or more is measured within 60 seconds using a grindometer. The flocculation test is carried out at 25° C. and 1 atm.

The cooling liquid medium may be a liquid containing a single component or may be obtained by combining two or more liquids. In the case where the cooling liquid medium is obtained by combining two or more liquids, as the cooling liquid medium used in the flocculation test, a mixture in which two or more liquids are mixed at the same mass ratio as in the cooling liquid medium used in the dispersion device is used.

The type of the cooling liquid medium is not particularly limited if the above flocculation test is satisfied. The cooling liquid medium is preferably a non-aqueous liquid medium, more preferably an organic solvent. Specifically, the cooling liquid medium can be selected from among the organic solvents for the raw material composition described below for use. The cooling liquid medium is preferably a liquid medium that does not have water as a main component. Specifically, the proportion of water is preferably less than 50% by mass. In the cooling liquid medium, the proportion of water is more preferably 10% by mass or less, even more preferably 1% by mass or less. Yet even more preferably, the cooling liquid medium substantially contains no water. By selecting, as the cooling liquid medium that cools the plunger part, a non-aqueous liquid medium having high affinity with the raw material composition, instead of water which has conventionally been widely used, even if the raw material composition leaks from the cylinder part and contacts the cooling liquid medium, the formation of aggregates due to a dispersoid or dispersant or the like can be suppressed.

It is sufficient that the cooling liquid medium satisfies the above flocculation test. However, the cooling liquid medium preferably satisfies the following conditions in addition to satisfying the flocculation test. The cooling liquid medium is preferably the same as the non-aqueous dispersed medium of the raw material composition. For example, in the case where the raw material composition contains a non-aqueous dispersed medium containing a single component, this non-aqueous dispersed medium is preferably used as the cooling liquid medium. In the case where the raw material composition contains multiple non-aqueous dispersed media, a single component, a combination of two or more components, or a combination of all the components from among the multiple non-aqueous media of the raw material composition may be used as the cooling liquid medium. In the case of using all the components, blending proportions of each component may be the same as or different from those of the non-aqueous dispersed medium of the raw material composition. Preferably, in the case where the raw material composition contains multiple non-aqueous dispersed media, the cooling liquid medium is a liquid medium containing the multiple non-aqueous dispersed media of the raw material composition at the same blending proportions.

In the method of one embodiment, a leakage rate of the raw material composition from the supply mechanism per 100 hours of operation, which is expressed by the following expression (1), is preferably 0.2% or less.

$$Leakage rate ( \% ) = ( leakage amount ( L ) of raw material composition from supply mechanism / supply amount ( L ) of raw material composition ) \times 100 \qquad ( 1 )$$

In expression (1), the leakage amount of the raw material composition from the supply mechanism is the amount of the raw material composition leaking from the supply mechanism to the cooling mechanism during 100 hours of operation. The supply amount of the raw material composition is the total amount discharged from the dispersion section during 100 hours of operation. The leakage amount of the raw material composition from the supply mechanism is obtained in accordance with the following procedure.
(1) When the gland packing is replaced, the cooling liquid medium is also replaced. The cooling liquid medium at this time is set as X(L).
(2) The liquid collected in the cooling liquid medium tank when the total operating time reaches 100 hours is set as Y(L). The leakage amount of the raw material composition from the supply mechanism is obtained using the following expression.

$$Leakage amount ( L ) of raw material composition from supply mechanism = Y ( L ) - X ( L )$$

From the viewpoint of efficiency in producing the dispersion composition using the dispersion device, the gland packing of the dispersion device is preferably replaced at a frequency of once or less per month. As the operating time of the dispersion device, it is desired that the life of the gland packing is several hundred hours or more. The amount of the raw material composition leaking from the supply mechanism per 100 hours of operation (from the beginning to the middle of the replacement interval) is an important index for estimating the life of the gland packing. When the start of deterioration of the seal member is not identified during 100 hours of operation, it can be predicted that leakage of the raw material composition from the supply mechanism in the subsequent operation is prevented. Hence, when the leakage rate is 0.2% or less per 100 hours of operation, it can be identified that the plunger part is efficiently cooled, and it can be predicted that deterioration of the gland packing in the subsequent operation is relatively prevented.

The leakage rate expressed by expression (1) is preferably 0.2% or less, more preferably 0.1% or less, and even more preferably 0.05% or less. If deterioration of the seal member is prevented and sealability of the sliding surface between the cylinder part of the high-pressure pump and the plunger is relatively ensured, the leakage rate expressed by expression (1) is preferably close to 0%.

### <Raw Material Composition>

The raw material composition supplied to the dispersion device is not particularly limited if it includes a dispersoid and a non-aqueous dispersed medium. The raw material composition may further contain a dispersant in order to obtain dispersion stability of the dispersoid. The raw material composition may contain an arbitrary component such as a resin emulsion, a surfactant, a binder resin, a wetting agent, a wetting and penetrating agent, and a leveling agent, as necessary.

The dispersoid may be inorganic particles, organic particles, inorganic-organic composite particles, or a combination thereof. The dispersoid is preferably particles that can be dispersed in a non-aqueous dispersed medium, and is preferably those showing insolubility in a non-aqueous dispersed medium. Examples of the inorganic particles include a carbon material, ceramics, and metal. Examples of the carbon material include a carbon material such as carbon black, a carbon nanotube, fullerene, graphene, multilayer graphene, and graphite. Examples of carbon black include acetylene black, furnace black, hollow carbon black, and Ketjen black. These carbon materials may be neutral, acidic, or basic, and may be oxidized or graphitized. Examples of ceramics include a metal oxide, a carbonate, a nitride, a phosphate, and a carbide. For example, calcium oxide, calcium carbonate, magnesium oxide, magnesium carbonate, magnesium phosphate, aluminum oxide, aluminum nitride, aluminum phosphate, boron nitride, silicon oxide, silicon nitride, silicon carbide, zirconium oxide, titanium oxide, kaolin clay, and indium tin oxide (ITO) may be mentioned. Examples of metal include zinc, lead, titanium, cadmium, iron, copper, cobalt, or an alloy thereof.

As the organic particles, resin particles are preferable. Examples thereof include polystyrene, polyurethane, polyester, polyamide, vinyl polymer, acrylic polymer, a composite polymer thereof; cellulose, and pulp fiber.

An inorganic pigment or an organic pigment may be used as the dispersoid. Examples of the organic pigment include azo-based, phthalocyanine-based, anthraquinone-based, perylene-based, perinone-based, quinacridone-based, thioindigo-based, dioxazine-based, isoindolinone-based, quinophthalone-based, azomethine azo-based, diketopyrrolopyrrole-based, and isoindoline-based pigments. More specific examples include Carmine 6B, Lake Red C, Permanent Red 2B, disazo yellow, pyrazolone orange, Carmine FB, Cromophtal Yellow, Cromophtal Red, phthalocyanine blue, phthalocyanine green, dioxazine violet, quinacridone magenta, quinacridone red, indanthrone blue, pyrimidine yellow, thioindigo bordeaux, thioindigo magenta, perylene red, perinone orange, isoindolinone yellow, diketopyrrolopyrrole red, aniline black, and a daylight fluorescent pigment. Furthermore, examples of the organic pigment include, among the colorants described in the Colour Index International (abbreviated as C.I.), C.I. Pigment Black, C.I. Pigment Blue, C.I. Pigment Green, C.I. Pigment Red, C.I. Pigment Violet, C.I. Pigment Yellow, C.I. Pigment Orange, and C.I. Pigment Brown, which are organic compounds or organometallic complexes.

Examples of the inorganic pigment include: a white pigment, such as titanium oxide, zinc oxide, zinc sulfide, barium sulfate, calcium carbonate, chromium oxide, and silica; and pigments other than the white pigment, such as aluminum powder, mica, bronze powder, chrome vermilion, yellow lead, cadmium yellow, cadmium red, aluminum hydroxide, ultramarine blue, navy blue, red iron oxide, yellow iron oxide, iron black, titanium oxide, and zinc oxide.

The above dispersoid may be surface-treated. One of the above dispersoids may be used alone, or two or more thereof may be used in combination. The content of the dispersoid in the raw material composition is not particularly limited if it is appropriately adjusted within a range allowing the dispersoid to be dispersed in the non-aqueous dispersed medium after the dispersion treatment according to the materials of the non-aqueous dispersed medium and the dispersoid.

As the non-aqueous dispersed medium, it is sufficient if a solvent capable of dispersing the dispersoid is used according to the type of the dispersoid, and an organic solvent is preferable. As the organic solvent, either a non-polar solvent or a polar solvent may be used, or these may be used in combination within a range allowing them to be mixed. Examples of the non-polar solvent include: an aliphatic hydrocarbon solvent, such as hexane, cyclohexane, and paraffin; an aromatic hydrocarbon solvent, such as benzene, toluene, and xylene; and other petroleum-based hydrocarbon solvents. Examples of the polar solvent include: an ester-based solvent, an ether-based solvent, an alcohol-based solvent, a ketone-based solvent, an amide-based solvent, a heterocyclic-based solvent, a sulfoxide-based solvent, a sulfone-based solvent, and a carbonate-based solvent.

More specifically, the following can be used as the non-aqueous dispersed medium: amide-based (such as N-methyl-2-pyrrolidone (NMP), N-ethyl-2-pyrrolidone (NEP), N,N-dimethylformamide, N,N-dimethylacetamide, N,N-diethylacetamide, and N-methylcaprolactam); heterocyclic-based (such as cyclohexylpyrrolidone, 2-oxazolidone, 1,3-dimethyl-2-imidazolidinone, and γ-butyrolactone); sulfoxide-based (such as dimethyl sulfoxide); sulfone-based (such as hexamethylphosphorotriamide and sulfolane); lower ketone-based (such as acetone and methyl ethyl ketone); carbonate-based (diethyl carbonate, dimethyl carbonate, ethyl methyl carbonate, fluoroethylene carbonate, propylene carbonate, and ethylene carbonate); tetrahydrofuran; and acetonitrile.

Furthermore, examples of the non-aqueous dispersed medium include formic acid, acetic acid, methanol, ethanol, propanol, methyl acetate, ethyl acetate, diethyl ether, and α-terpineol. One of the above non-aqueous dispersed media may be used alone, or two or more thereof may be used in combination.

As the dispersant, either a resin-type dispersant or a surfactant can be used. According to the properties required for dispersion of the dispersoid, a suitable type of dispersant can be used in a suitable amount.

As the resin-type dispersant, a (meth)acrylic polymer, a polymer derived from an ethylenically unsaturated hydrocarbon, a cellulose-based derivative, a copolymer thereof, or the like, can be used. Examples of the polymer derived from an ethylenically unsaturated hydrocarbon include polyvinyl alcohol-based resin, polyvinylpyrrolidone-based resin, polyacrylonitrile-based resin, and nitrile rubbers. Examples of the polyvinyl alcohol-based resin include: polyvinyl alcohol; modified polyvinyl alcohol having a functional group (for example, acetyl group, sulfo group, carboxyl group, carbonyl group, or amino group) other than a hydroxyl group; polyvinyl alcohol modified with various salts; other anion-modified or cation-modified polyvinyl alcohols; and polyvinyl acetal (such as polyvinyl acetoacetal and polyvinyl butyral) acetal-modified (such as acetoacetal-modified or butyral-modified) with aldehydes. Examples of the polyacrylonitrile-based resin include a homopolymer of polyacrylonitrile, a copolymer of polyacrylonitrile, and a modified product thereof. Preferred is a polyacrylonitrile-based resin having at least one selected from the group consisting of: an active hydrogen group such as hydroxyl group, carboxy group, primary amino group, secondary amino group, and mercapto group; a basic group; and an alkyl group derived and introduced from (meth)acrylic acid alkyl ester or α-olefin, or the like. For example, an acrylonitrile copolymer described in Japanese Patent Laid-open No. 2020-163362 can be used. Examples of the nitrile rubbers include acrylonitrile butadiene rubber and hydrogenated acrylonitrile butadiene rubber. Examples of the cellulose-based derivative include cellulose acetate, cellulose acetate butyrate, cellulose butyrate, cyanoethylcellulose, ethylhydroxyethylcellulose, nitrocellulose, methyl cellulose, ethyl cellulose, hydroxyethyl cellulose, hydroxypropyl cellulose, hydroxypropylmethylcellulose, carboxymethylcellulose, and a copolymer thereof. The dispersants described in WO 2008/108360, Japanese Patent Laid-open No. 2018-192379, Japanese Patent Laid-open No. 2019-087304, Japanese Patent No. 6524479, and Japanese Patent Laid-open No. 2009-026744 may be used. However, the present invention is not limited thereto. Particularly preferred are: methyl cellulose, ethyl cellulose, polyvinyl alcohol, polyvinyl butyral, polyvinylpyrrolidone, a homopolymer of polyacrylonitrile, a copolymer of polyacrylonitrile, and hydrogenated acrylonitrile butadiene rubber. A polymer obtained by introducing other substituents into some of these polymers, a modified polymer or the like may also be used.

The surfactant may be any of an anionic surfactant, a cationic surfactant, an amphoteric ionic surfactant, and a nonionic surfactant. The amount of the dispersant is preferably 5 to 300 parts by mass, more preferably 10 to 200 parts by mass, and even more preferably 15 to 100 parts by mass with respect to 100 parts by mass of the dispersoid.

The content of the dispersoid with respect to the total amount of the raw material composition varies depending on the specific gravity of the dispersoid, and is preferably 0.1 to 80% by mass, more preferably 0.5 to 60% by mass, and even more preferably 0.7 to 50% by mass. The raw material composition preferably has a solid content of 0.5 to 80% by mass, more preferably 0.7 to 60% by mass, and even more preferably 1 to 50% by mass.

### <Raw Material Composition Containing Carbon Nanotube>

In the dispersion device according to one embodiment, particles can be dispersed by high-pressure treatment without being applied with mechanical impact. Thus, the dispersion device is suitable for use in dispersing particles while maintaining the shape of the particles. Furthermore, the dispersion device is suitable for use in defibrating a mass such as fibrous particles and improving dispersibility. For example, the dispersion device can be suitably used in a method for producing a carbon nanotube dispersion liquid. Hereinafter, carbon nanotube will also be referred to as CNT.

In a raw material composition containing a carbon nanotube, the above non-aqueous dispersed medium can be used as a non-aqueous dispersed medium. In the raw material composition containing a carbon nanotube, the non-aqueous dispersed medium preferably contains an aprotic solvent and a non-polar solvent, more preferably contains an aprotic solvent, and even more preferably contains an aprotic polar solvent. The aprotic polar solvent is relatively able to prevent flocculation of carbon nanotubes and is excellent in terms of solubility of a resin-type dispersant suitable for dispersing carbon nanotubes. An amide-based solvent is preferably contained. In particular, at least one selected from the group consisting of N-methyl-2-pyrrolidone, N-ethyl-2-pyrrolidone and 1-n-octyl-2-pyrrolidone is more preferably contained.

The carbon nanotube used in the raw material composition before being dispersed preferably has the following properties. The CNT is of a shape in which planar graphite is wound into a cylindrical shape. The CNT includes a single-walled CNT and a multi-walled CNT, or a mixture thereof. A single-walled CNT has a structure in which a single layer of graphite is wound. A multi-walled CNT has a structure in which two or three or more layers of graphite are wound. A sidewall of a CNT does not have to have a graphite structure. A CNT including a sidewall having an amorphous structure, for example, is also a CNT in the present specification.

The shape of the CNT is not limited. Examples of the shape include a variety of shapes including a needle-like shape, a cylindrical tube-like shape, a fishbone-like shape (fishbone or cup-stacked type), a playing card-like shape (platelet), and a coil-like shape. Among them, the CNT is preferably of a needle-like shape or a cylindrical tube-like shape. The CNT may be of a single shape or of a combination of two or more shapes.

Examples of forms of the CNT include a graphite whisker, filamentous carbon, a graphite fiber, an ultrafine carbon tube, a carbon tube, a carbon fibril, a carbon microtube, and a carbon nanofiber. The carbon nanotube may be of a single form or a combination of two or more forms from among the above.

The CNT has an average outer diameter of preferably 1 nm or more, more preferably 1.2 nm or more, and has an average outer diameter of preferably 30 nm or less, more preferably 20 nm or less, and even more preferably 15 nm or less. The average outer diameter of the CNT can be calculated by the following way. First, the CNT is observed and photographed using a transmission electron microscope. Any 300 CNTs in an observation photograph are selected, and their respective outer diameters are measured and averaged to obtain the average outer diameter.

The CNT has an average fiber length of preferably 0.5 μm or more, more preferably 0.8 μm or more, and even more preferably 1.0 μm or more, and has an average fiber length of preferably 20 μm or less, more preferably 10 μm or less. The average fiber length of the CNT can be calculated by the following way. First, the CNT is observed and photographed using a scanning electron microscope. Any 300 CNTs in an observation photograph are selected, and their respective fiber lengths are measured and averaged to obtain the average fiber length.

An aspect ratio is a value obtained by dividing the fiber length of the CNT by the outer diameter of the CNT. A representative aspect ratio can be obtained using an average fiber length value and an average outer diameter value. The higher the aspect ratio of a conductive material, the higher the conductivity can be obtained when an electrode is formed. The CNT has an aspect ratio of preferably 30 or more, more preferably 50 or more, and even more preferably 80 or more. The aspect ratio is preferably 100,000 or less, more preferably 30,000 or less, and even more preferably 10,000 or less.

The CNT has specific surface area of preferably 100 m²/g or more, more preferably 150 m²/g or more, and even more preferably 200 m²/g or more, and has specific surface area of preferably 1,200 m²/g or less, more preferably 1,000 m²/g or less. The specific surface area of the CNT is calculated by a Brunauer-Emmett-Teller (BET) method using nitrogen adsorption measurement.

The carbon nanotube may be a surface-treated carbon nanotube. The carbon nanotube may be a carbon nanotube derivative to which a functional group represented by carboxy group is attached. A carbon nanotube including an organic compound, metal atoms, or a substance represented by fullerene can also be used.

The raw material composition containing a carbon nanotube may contain a dispersant. Examples of the dispersant include those mentioned above. In order to further improve dispersion stability of the carbon nanotube in the non-aqueous dispersed medium, a resin-type dispersant is preferably used. Particularly preferred are: methyl cellulose, ethyl cellulose, polyvinyl alcohol, polyvinyl butyral, polyvinylpyrrolidone, a homopolymer of polyacrylonitrile, a copolymer of polyacrylonitrile, and hydrogenated acrylonitrile butadiene rubber. The raw material composition containing a carbon nanotube may further contain an arbitrary component such as the binder resin mentioned above.

The content of the carbon nanotube is preferably 0.1 to 20% by mass, more preferably 0.5 to 15% by mass, and even more preferably 0.7 to 10% by mass, with respect to the total amount of the raw material composition. The amount of the dispersant is preferably 5.0 to 300 parts by mass in terms of mass ratio with respect to the carbon nanotube. The raw material composition containing a carbon nanotube preferably has a solid content of 0.5 to 50% by mass, more preferably 0.7 to 30% by mass, and even more preferably 1 to 20% by mass.

### OTHER EMBODIMENTS

Hereinafter, other embodiments of a method for producing a dispersion composition containing a dispersoid, a non-aqueous dispersed medium, and a dispersant using a dispersion device will be described. In this method, the raw material composition contains a dispersoid, a non-aqueous dispersed medium, and a dispersant. By supplying the raw material composition from the supply mechanism to the dispersion mechanism for dispersion treatment, a dispersion composition can be obtained. As the dispersion device for producing the dispersion composition, one described above can be used.

In the dispersion composition in which the dispersoid is dispersed in the non-aqueous dispersed medium using the dispersant, the dispersant preferably exhibits solubility in the non-aqueous dispersed medium and preferably has a property of adsorbing the dispersoid in the non-aqueous dispersed medium. In such a dispersion composition, the type of each of the non-aqueous dispersed medium, the dispersoid, and the dispersant is appropriately selected for dispersion stability. On the other hand, in the case where the dispersion composition is added to other solvents such as water, due to factors such as low solubility of the dispersant in the other solvents, the dispersant may be separated from the dispersoid, the dispersion stability may be reduced, and the dispersoid is likely to aggregate.

Accordingly, the cooling liquid medium is preferably a liquid medium in which no solid precipitates are formed at 25° C. in a state in which a solution of the non-aqueous dispersed medium containing 5% by mass of the dispersant and the cooling liquid medium are mixed at a mass ratio of 1:1. As specific determination criteria, at 25° C. and 1 atm, a solution of a non-aqueous dispersed medium containing 5% by mass of a dispersant contained in a raw material composition and a cooling liquid medium are mixed at a mass ratio of 1:1, stirred at 2,000 rpm for 30 seconds using a rotation/revolution stirring device and subjected to filtration through a 30 μm opening filter. Then, the solid content (X % by mass) of the filtrate is measured. If the solid content of the filtrate has decreased by 5% or more from a theoretical solid content (2.5% by mass), it can be determined that precipitation has occurred. Specifically, if an expression “((2.5% by mass−X % by mass)/2.5% by mass)×100” satisfies less than 5%, it is determined that no solid precipitates are formed. If the dispersant does not dissolve in the non-aqueous dispersed medium at 5% by mass, the above test is carried out at the maximum soluble concentration. Similarly, if the solid content has decreased by 5% or more from the theoretical solid content, it is determined that precipitation has occurred.

In still another embodiment, the cooling liquid medium is preferably a liquid medium that dissolves 0.1% by mass or more of the dispersant contained in the raw material composition at 25° C. The cooling liquid medium is evaluated for the solubility of the dispersant at 25° C. and 1 atm. The solubility of the dispersant with respect to the cooling liquid medium is expressed as a percentage of the mass of the dispersant with respect to the total mass of the dispersant and the cooling liquid medium. The solubility of the dispersant with respect to the cooling liquid medium is preferably 0.1% by mass or more, more preferably 0.5% by mass or more, and even more preferably 1.0% by mass or more. By the cooling liquid medium dissolving the dispersant of the raw material composition, even if the raw material composition leaking from the supply mechanism contacts the cooling liquid medium, deterioration of the function of the dispersant can be suppressed, the stability of the system can be maintained, and flocculation of the dispersoid can be prevented.

Specifically, the solubility of the dispersant with respect to the cooling liquid medium can be determined in accordance with the following procedure.
(1) A liquid medium containing a predetermined amount (Y % by mass) of the dispersant with respect to the total amount of the cooling liquid medium and the dispersant is prepared. Stirring is performed at 1,500 rpm for 24 hours using a high-speed disperser homodisper to mix the liquid medium. If the dispersant lump is large, the dispersant lump is cut into pieces of 1 cm square or less before use.
(2) After filtration using a 30 μm opening filter, the solid content (X % by mass) of the filtrate is measured. If a ratio “((Y % by mass−X % by mass)/Y % by mass)×100” at which the solid content (X % by mass) of the filtrate decreases from the theoretical solid content (Y % by mass) is less than 20%, it is determined that dissolution has occurred.

### Still Other Embodiments

Hereinafter, still other embodiments of a method for producing a dispersion composition using a dispersion device will be described. As the dispersion device for producing the dispersion composition, one described above can be used.

According to this embodiment, provided is a dispersion composition production method using a dispersion device. The dispersion device is equipped with a dispersion mechanism that disperses a raw material composition, a supply mechanism that includes a plunger part and supplies the raw material composition to the dispersion mechanism, and a cooling mechanism that cools the plunger part using a cooling liquid medium. The dispersion composition production method satisfies at least one of (i), (ii), and (iii) below.
(i) The raw material composition contains a non-aqueous dispersion medium and a dispersoid. The cooling liquid medium is a liquid medium that results in the number of particles of 10 μm or more in a flocculation test mentioned below being 0 to 50.

### (Flocculation Test)

A composition identical to the raw material composition is subjected to a dispersion treatment using a bead mill or a high-pressure homogenizer. A test dispersion liquid is prepared having a particle size of less than 10 μm as measured with a grindometer (0 to 100 μm). The test dispersion liquid and the cooling liquid medium are mixed at a mass ratio of 1:1 at 25° C. to prepare a test sample, and the number of particles of 10 μm or more in the test sample is identified using a grindometer (0 to 100 μm).
(ii) The raw material composition contains a dispersoid, a non-aqueous dispersed medium, and a dispersant. The cooling liquid medium is a liquid medium in which no solid precipitates are formed at 25° C. in a state in which a solution of the non-aqueous dispersed medium containing 5% by mass of the dispersant and the cooling liquid medium are mixed at a mass ratio of 1:1.
(iii) The raw material composition contains a dispersoid, a non-aqueous dispersed medium, and a dispersant. At 25° C., the cooling liquid medium is a liquid medium in which 0.1% by mass or more of the dispersant contained in the raw material composition is dissolved.

In this embodiment, it is sufficient to satisfy at least one of (i), (ii), and (iii). Preferably, (i) is satisfied. In the cases where the raw material composition contains a dispersant, it is more preferable that (ii) or (iii) is satisfied together with (i), and even more preferable that (ii) and (iii) are satisfied together with (i).

### EXAMPLES

The present invention will further be described in detail below with reference to examples. The present invention is not limited to the following examples unless it exceeds the gist thereof. Unless otherwise specified, “parts” represents “parts by mass,” and “%” represents “% by mass.”

### (Dispersion Device)

In Example 1, dispersion was performed using a valve-type high-pressure homogenizer “HC3-5” (trade name) manufactured by Sanmaru Machinery. In Example 2, a dispersion composition obtained by one passing of dispersion under the operating conditions of a single nozzle chamber with 100 MPa using a nozzle-type high-pressure homogenizer “Starburst 100” (trade name) manufactured by Sugino Machine was subjected to dispersion using a valve-type high-pressure homogenizer “HC3-5” (trade name) manufactured by Sanmaru Machinery. The dispersion conditions were as shown in Table 1. In the table, “Ex.” indicates example number, and “No.” indicates formulation number. The cooling mechanism was as shown in FIG. 2. The cooling liquid medium was supplied to the cooling liquid medium tank of the cooling mechanism, and the cooling liquid medium was circulated at a flow rate of 2 L/H during operation of the dispersion device.

### (Raw Material Composition)

Each component was mixed according to the following formulations as a raw material composition.

### Formulation 1:

Carbon nanotube (trade name: “100P”, manufactured by Kumho), 3% by mass
N-methyl-2-pyrrolidone (NMP), 96% by mass
Dispersant (trade name: “Zetpol 2010L”, manufactured by Nippon Zeon), 1% by mass

### Formulation 2:

Carbon nanotube (trade name: “100P”, manufactured by Kumho), 2% by mass
Butyl acetate, 90% by mass
Dispersant (trade name: “DISPERBYK-111”, manufactured by BYK; solid content 95%), 8% by mass

### Formulation 3:

Carbon black (trade name: “Denka Black Granular”, manufactured by Denka), 20% by mass N-methyl-2-pyrrolidone (NMP), 78.95% by mass
Dispersant (trade name: “Polyacrylonitrile Mw 150,000”, manufactured by Sigma-Aldrich), 1% by mass
pH adjuster (trade name: “Sodium Hydroxide”, manufactured by Fujifilm Wako Pure Chemical Industries), 0.05% by mass

### Formulation 4:

Titanium oxide (trade name: “CR-95”, manufactured by Ishihara Sangyo), 50% by mass Methyl ethyl ketone, 44.0% by mass
Dispersant (trade name: “DISPERBYK-182”, manufactured by Lubrizol Japan; solid content 43%), 6.0% by mass

### Formulation 5:

ITO (trade name: “E-ITO”, manufactured by Mitsubishi Materials), 9% by mass α-terpineol, 87% by mass
Dispersant (trade name: “DISPERBYK-111”, manufactured by BYK; solid content 95%), 1% by mass

### Formulation 6:

Carbon nanotube (trade name: “100P”, manufactured by Kumho), 1% by mass Methyl ethyl ketone (MEK), 89% by mass
Dispersant (trade name: “EFKA PX 4320”, manufactured by BASF; solid content 50%), 10% by mass

### (Cooling Liquid Medium)

The cooling liquid media shown in Table 1 were prepared.

### (Flocculation Test)

With respect to the combinations of raw material compositions and cooling liquid media shown in Table 1, a flocculation test was carried out in accordance with the following procedure. The flocculation test was carried out in an environment at 25° C.
(1) A composition identical to the raw material composition was subjected to a dispersion treatment using a bead mill, and a test dispersion liquid was prepared that results in a particle size of less than 10 μm as measured with a grindometer (0 to 100 μm). As the dispersion device, “Starmill LMZ 2” manufactured by Ashizawa Finetech was used. The dispersion conditions included a peripheral speed of 12 m/s, and dispersion was performed for the number of times of passing until the particle diameter became less than 10 μm.
(2) 10 g of the test dispersion liquid and 10 g of the cooling liquid medium were measured in a stirring container (“001 Stirring Container” manufactured by Kinki Yoki), stirred at 2,000 rpm for 30 seconds using a thinky mixer, and a test sample was prepared.
(3) After production of the test sample, the number of particles of 10 μm or more in the test sample was identified within 60 seconds using a grindometer (0 to 100 μm).

### <Grindometer>

The grindometer used in (1) and (3) of the flocculation test was as follows.
Gauge model number: “GS0-100”, manufactured by Taiyu Kizai
Groove depth: 0 μm to 100 μm; scale interval: 10 μm

### <Determination Criteria>

The results of the flocculation test were evaluated based on the number of particles of 10 μm or more identified in the test sample using the following criteria. The results are shown in Table 1.
∘: there were no particles of 10 μm or more (no flocculation has occurred)
Δ: there were 1 to 50 particles of 10 μm or more (slight flocculation has occurred)
x: there were 51 or more particles of 10 μm or more (flocculation has occurred)

### (Evaluation of Life of Gland Packing)

The dispersion device was operated for 100 hours using the combinations of raw material compositions and cooling liquid media shown in Table 1. The leakage amount of the raw material composition from the supply mechanism (plunger part) and the supply amount of the raw material composition per 100 hours of operation were measured, and the leakage rate (%) was calculated from the following expression (1).

$$Leakage rate ( \% ) = ( leakage amount ( L ) of raw material composition from supply mechanism / treatment amount ( L ) of raw material composition ) \times 100 \qquad ( 1 )$$

The leakage amount of the raw material composition from the supply mechanism was obtained in accordance with the following procedure.
(1) When the gland packing was replaced, the cooling liquid medium was also replaced. The cooling liquid medium at this time was set as X(L).
(2) The liquid collected in the cooling liquid medium tank when the total operating time reached 100 hours was set as Y(L). The leakage amount of the raw material composition from the supply mechanism was obtained using the following expression.

$$Leakage amount ( L ) of raw material composition from supply mechanism = Y ( L ) - X ( L )$$

From the above leakage rate obtained, the results of the flocculation test were evaluated according to the following criteria. The results are shown in Table 1.

### <Determination Criteria>

∘: leakage rate was 0.10% or less
Δ: leakage rate was more than 0.10% and 0.20% or less
x: leakage rate was more than 0.20%

### (Precipitation Test)

With respect to the combinations of dispersants and cooling liquid media shown in Table 1, a precipitation test was carried out in accordance with the following procedure. The precipitation test was carried out in an environment at 25° C.
(1) The dispersant contained in the raw material composition was dissolved in a non-aqueous dispersed medium at a concentration of 5% by mass.
(2) 30 g of a non-aqueous dispersed medium solution in which the dispersant was dissolved at a concentration of 5% by mass and 30 g of a cooling liquid medium were measured in a stirring container (“001 Stirring Container” manufactured by Kinki Yoki), and stirred at 2,000 rpm for 30 seconds using a thinky mixer.
(3) After filtration using a 30 μm opening filter, the solid content of the filtrate was measured. If the solid content (X % by mass) of the filtrate decreased by 5% or more from a theoretical solid content (2.5% by mass), specifically, if the expression “((2.5% by mass−X % by mass)/2.5% by mass)×100” satisfied 5% or more, it was determined that precipitation has occurred. The solid content of the filtrate was measured as follows: 5 g of the filtrate was measured on an aluminum plate, followed by drying in an oven at 200° C. for 2 hours, and the solid content was calculated from the following expression using the mass before and after the above process.

$$Solid content ( \% by mass ) = ( ( mass of aluminum plate + filtrate after at \\ 200 ° C . for 2 hours / ( mass of aluminum plate + filtrate ) ) \times 100$$

### <Determination Criteria>

The results of the precipitation test were evaluated using the following criteria. The results are shown in Table 1.
∘: the solid content of the filtrate decreased by less than 5% from the theoretical solid content (2.5% by mass) or did not decrease (no precipitation has occurred)
x: the solid content of the filtrate decreased by 5% or more from the theoretical solid content (2.5% by mass) (precipitation has occurred)

### (Dissolution Test)

With respect to the combinations of dispersants and cooling liquid media shown in Table 1, a dissolution test was carried out in accordance with the following procedure. The dissolution test was carried out in an environment at 25° C.
(1) 499.5 g of the cooling liquid medium and 0.5 g of the dispersant contained in the raw material composition were measured in a 1 L container, stirred at 1,500 rpm for 24 hours using a high-speed disperser homodisper, and a cooling liquid medium containing 0.1% by mass of the dispersant was produced.
(2) After filtration using a 30 μm opening filter, the solid content of the filtrate was measured. If the solid content (X % by mass) of the filtrate decreased by 20% or more from a theoretical solid content (0.1% by mass), specifically, if an expression “((0.1% by mass−X % by mass)/0.1% by mass)×100” satisfied 20% or more, it was determined that no dissolution has occurred. The solid content of the filtrate was measured as follows: 5 g of the filtrate was measured on an aluminum plate, followed by drying in an oven at 200° C. for 2 hours, and the solid content was calculated from the following expression using the mass before and after the above process.

$$Solid content ( \% by mass ) = ( ( mass of aluminum plate + filtrate after at 200 ° C . for 2 hours ) / ( mass of aluminum plate + filtrate ) ) \times 100$$

### <Determination Criteria>

The results of the dissolution test were evaluated using the following criteria. The results are shown in Table 1.
∘: the solid content of the filtrate decreased by less than 20% from the theoretical solid content (0.1% by mass) or did not decrease (dissolution has occurred)
x: the solid content of the filtrate decreased by 20% or more from the theoretical solid content (0.1% by mass) (no dissolution has occurred)

TABLE 1-1
Formulations and evaluation results of Example 1

| | | Dispersion | | | | | | | | |
|---|---|---|---|---|---|---|---|---|---|---|
| | | conditions of | Raw material composition | | | | | | | Life of |
| | | dispersion | | Dispersed | Cooling liquid | Flocculation | | Precipitation | Dissolution | gland |
| Ex. | No. | device | Dispersoid | medium | medium | test | Dispersant | test | test | packing |
| 1 | 1 | [Treatment | Carbon | N-methyl-2- | N-methyl-2- | ∘ | Zetpol 2010L | ∘ | ∘ | ∘ |
| | | pressure] | nanotube | pyrrolidone | pyrrolidone | | | | | |
| | | 100 MPa | (100P) | (NMP) | (NMP) | | | | | |
| | | [Dispersion | | | γ-butyrolactone | ∘ | | ∘ | ∘ | ∘ |
| | | treatment | | | (GBL) | | | | | |
| | | method] | | | Methyl ethyl | ∘ | | x | x | Δ |
| | | flat valve | | | ketone | | | | | |
| | | [Flow rate of | | | (MEK) | | | | | |
| | | raw material | | | Isopropyl alcohol | Δ | | x | x | Δ |
| | | composition] | | | (IPA) | | | | | |
| | | 2000 L/H | | | Water | x | | x | x | x |
| | 2 | | Carbon | Butyl acetate | Ethyl acetate | ∘ | DISPERBYK-111 | ∘ | ∘ | ∘ |
| | | | nanotube | | Isopropyl alcohol | ∘ | Polyacrylonitrile | ∘ | ∘ | ∘ |
| | | | (100P) | | (IPA) | | | | | |
| | | | | | Water | x | | x | x | x |
| | 3 | | Carbon black | N-methyl-2- | N-methyl-2- | ∘ | | ∘ | ∘ | ∘ |
| | | | (Denka Black | pyrrolidone | pyrrolidone | | | | | |
| | | | Granular) | (NMP) | (NMP) | | | | | |
| | | | | | γ-butyrolactone | ∘ | | ∘ | ∘ | ∘ |
| | | | | | (GBL) | | | | | |
| | | | | | Methyl ethyl | ∘ | | x | x | Δ |
| | | | | | ketone | | | | | |
| | | | | | (MEK) | | | | | |
| | | | | | Isopropyl alcohol | Δ | | x | x | Δ |
| | | | | | (IPA) | | | | | |
| | | | | | Water | x | | x | x | x |
| | 4 | | Titanium oxide | Methyl ethyl | Methyl ethyl | ∘ | DISPERBYK-182 | ∘ | ∘ | ∘ |
| | | | (CR-95) | ketone | ketone | | | | | |
| | | | | (MEK) | (MEK) | | | | | |
| | | | | | Toluene | ∘ | | ∘ | ∘ | ∘ |
| | | | | | Hexane | Δ | | x | x | Δ |
| | | | | | Water | x | | x | x | x |

TABLE 1-2
Formulations and evaluation results of Example 2

| | | Dispersion | | | | | | | | |
|---|---|---|---|---|---|---|---|---|---|---|
| | | conditions of | Raw material composition | | | | | | | Life of |
| | | dispersion | | Dispersed | Cooling liquid | Flocculation | | Precipitation | Dissolution | gland |
| Ex. | No. | device | Dispersoid | medium | medium | test | Dispersant | test | test | packing |
| 2 | 1 | [Treatment | Carbon | N-methyl-2- | N-methyl-2- | ∘ | Zetpol 2010L | ∘ | ∘ | ∘ |
| | | pressure] | nanotube | pyrrolidone | pyrrolidone | | | | | |
| | | 100 MPa | (100P) | (NMP) | (NMP) | | | | | |
| | | [Dispersion | | | Isopropyl alcohol | Δ | | x | x | Δ |
| | | treatment | | | (IPA) | | | | | |
| | | method] | | | Water | x | | x | x | x |
| | 5 | flat valve | ITO | α-terpineol | α-terpineol | ∘ | DISPERBYK-111 | ∘ | ∘ | ∘ |
| | | [Flow rate of | (E-ITO) | | Ethanol | ∘ | | ∘ | ∘ | ∘ |
| | | raw material | | | Water | x | | x | x | x |
| | 6 | composition] | Carbon | Methyl ethyl | Methyl ethyl | ∘ | EFKA 4320 | ∘ | ∘ | ∘ |
| | | 2000 L/H | nanotube | ketone | ketone | | | | | |
| | | | (100P) | (MEK) | (MEK) | | | | | |
| | | | | | Toluene | ∘ | | ∘ | ∘ | ∘ |
| | | | | | Water | x | | x | x | x |

It is known from the above tables that, in the examples where no aggregates were formed in the results of the flocculation test, the leakage rate of the cooling liquid medium from the plunger part was reduced, and the life of the gland packing was extended. It is also known that, even in the examples where the number of aggregates formed was small, the leakage rate of the cooling liquid medium from the plunger part was reduced, and the life of the gland packing was extended. According to the results of the flocculation test, it is known that in the examples where a large number of aggregates were formed, the leakage rate of the cooling liquid medium from the plunger part was increased, and the life of the gland packing was shortened.

In the examples where it was evaluated according to the precipitation test that no solid precipitates were generated when a non-aqueous dispersed medium containing 5% by mass of a dispersant was mixed with a cooling liquid medium at a mass ratio of 1:1, it is known that the life of the gland packing was extended. In the examples where it was evaluated according to the flocculation test that the dispersant has dissolved in the cooling liquid media containing 0.1% by mass of the dispersant, it is known that the life of the gland packing was extended.

Although the present invention has been described above with reference to the above several embodiments, the present invention is not limited to the above several embodiments. Various changes can be made to the configurations or details of the present invention within the scope of the present invention.

The disclosure of the present application is related to the subject matter described in Japanese Patent Application No. 2022-014907 filed on Feb. 2, 2022, the entire disclosure content of which is incorporated herein by reference.

### DESCRIPTION OF REFERENCE NUMERALS

10: plunger; 20: high-pressure pump; 21: cylinder part; 24: gland packing; 30: dispersion section; 31: valve seat; 32: impact ring; 33: homogenous valve; 40: cooling mechanism; 41: cooling liquid medium tank; 42: cooling section; 43: collection container; 50: raw material composition tank; 100: dispersion device

To the claims:

1. A dispersion composition production method, using a dispersion device equipped with a dispersion mechanism that disperses a raw material composition, a supply mechanism that comprises a plunger part and supplies the raw material composition to the dispersion mechanism, and a cooling mechanism that cools the plunger part using a cooling liquid medium, wherein
the raw material composition comprises a non-aqueous dispersed medium and a dispersoid; and
the cooling liquid medium is a liquid medium that results in the number of particles of 10 μm or more in a flocculation test mentioned below being 0 to 50,
in the flocculation test, a composition identical to the raw material composition is subjected to a dispersion treatment using a bead mill or a high-pressure homogenizer, a test dispersion liquid is prepared having a particle size of less than 10 μm as measured with a grindometer (0 to 100 μm),
the test dispersion liquid and the cooling liquid medium are mixed at a mass ratio of 1:1 at 25° C. to prepare a test sample, and the number of particles of 10 μm or more in the test sample is identified using a grindometer (0 to 100 μm).

2. The dispersion composition production method according to claim 1, wherein
the non-aqueous dispersed medium of the raw material composition and the cooling liquid medium contain the same liquid medium.

3. The dispersion composition production method according to claim 1, wherein
a leakage rate of the raw material composition from a supply mechanism per 100 hours of operation expressed by the following expression (1) is 0.2% or less.
$$leakage rate ( \% ) = ( leakage amount ( L ) of raw material composition from supply mechanism / supply amount ( L ) of raw material composition ) \times 100 \qquad ( 1 )$$

4. A dispersion composition production method, using a dispersion device equipped with a dispersion mechanism that disperses a raw material composition, a supply mechanism that comprises a plunger part and supplies the raw material composition to the dispersion mechanism, and a cooling mechanism that cools the plunger part using a cooling liquid medium, wherein
the raw material composition comprises a dispersoid, a non-aqueous dispersed medium, and a dispersant, the cooling liquid medium is a liquid medium in which no solid precipitates are formed at 25° C. in a state in which a solution of the non-aqueous dispersed medium containing 5% by mass of the dispersant and the cooling liquid medium are mixed at a mass ratio of 1:1.

5. A dispersion composition production method, using a dispersion device equipped with a dispersion mechanism that disperses a raw material composition, a supply mechanism that comprises a plunger part and supplies the raw material composition to the dispersion mechanism, and a cooling mechanism that cools the plunger part using a cooling liquid medium, wherein
the raw material composition comprises a dispersoid, a non-aqueous dispersed medium, and a dispersant; and
at 25° C., the cooling liquid medium is a liquid medium in which 0.1% by mass or more of the dispersant contained in the raw material composition is dissolved.
